(19) United States
(12) Patent Application Publication
(10) Pub. No.: US 2011/0170800 A1
(43) Pub. Date: Jul. 14, 2011

(54) RENDERING A CONTINUOUS OBLIQUE IMAGE MOSAIC

(75) Inventors: James C. Curlander, Lafayette, CO (US); Mher Hakobyan, Bellevue, WA (US)

(73) Assignee: MICROSOFT CORPORATION, Redmond, WA (US)

(21) Appl. No.: 12/687,112

(22) Filed: Jan. 13, 2010

(51) Int. Cl. G06K 9/32

(52) U.S. Cl. 382/294; 382/305

(57) ABSTRACT

A plurality of images may be combined around a central image to form one image. In one example, aerial photographs of a geographic area are taken and stored in a database, and a user requests to see some geographic region. The photo whose center is closest to the user's selected region is chosen as the center. If that photo encompasses the entire selected region, then that photo may be delivered to the user. If it takes several photos to contain the selected region, then photos from surrounding areas are chosen and are transformed to match the perspective of the central photo. The transformed photos are then stitched to the central photo and shown to the user. High-resolution photos may be delivered to a client from a server, and the transformation and stitching calculations may be performed by the client.

### BACKGROUND

An image mosaic is a collection of small images that are combined to form a larger image. Image mosaics are sometimes used to create aerial images of a geographic area for a mapping application. For example, many photos of a geographic area may be taken from an airplane, where each photo represents a small region of the overall geographic area. The images may be combined in a mosaic. Even though no single photo encompassing the entire geographic area was actually taken, the mosaic will appear as if it is one large photo of the area.

Mosaics are typically pre-calculated into a single large image, which is broken down into tile pyramids, stored on a server, and delivered to a user upon request. For example, a user of an Internet map application may request to see an aerial image of a particular street. Thus, the server looks up the region of the pre-calculated mosaic that the user wants to see, and delivers this region to the user's machine for viewing. There are several issues with this approach.

First, pre-calculating a mosaic for all of the area that a map application covers is computationally intensive. It may take hundreds or thousands of photos to cover an average-sized city. If a map application seeks to provide aerial imagery of, say, all large and mid-sized cities in the United States, it may have to process millions of photos to create the mosaics, often at the expense of millions of hours of computer time.

Additionally, the image quality of a pre-calculated mosaic is likely to suffer for various reasons. The images that are taken from an airplane are often very high resolution images. But when the images are stored as part of the pre-calculated mosaic, they are often stored at reduced resolution to save space. Moreover, since each image is taken at a different location from a moving plane, they are warped in various ways to make them fit together in one mosaic. This warping often creates unnatural-looking projections.

### SUMMARY

Images may be dynamically combined, and the combination may be presented to a user. When a user makes a request to see an image of a specific region, images taken in the vicinity of the requested region are retrieved from a database. One image is chosen to represent the center of the requested region. For example, the image whose boresight is nearest to the center of the requested region may be chosen to represent the central part of the requested region. Other images are then chosen to represent the surrounding parts of the requested region.

In order to make the image appear as a natural projection, the central image is presented at the original orientation at which it was taken. The surrounding images are then transformed (e.g., warped, re-sized, etc.) to match the orientation of the central image. Since the user is likely to focus attention on the center of the image, presenting the central image at its original orientation may make the entire image appear more natural to a user. While transformed images may be used in the areas surrounding the center, these areas are less likely than the central image to draw the user's attention, so they are unlikely to detract much from the perception of image quality.

In one example, images are delivered from a server to a client, and the calculations to perform the transformations may be performed on the client machine. Thus, when a user requests to see a specific region, the images to be used for the center and surrounding areas of that region may be requested from a server. The client may have software that allows it to perform the appropriate transformations on the surrounding images, and to combine the central and surrounding images into one more-or-less seamless image. The images that are delivered to the client to be transformed and combined may be the original high-resolution images that were captured by the camera.

In one example, the images may be aerial images taken from an airplane, and a map application may use these images to show objects at ground level (e.g., houses on a street). However, the techniques described herein may be used with any type of images and in any type of application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process in which an image may be created and shown to a user.

FIG. 2 is an elevation of a scenario in which photographs of a geographic area are taken from an airplane.

FIG. 3 is a perspective view of the scenario shown in FIG. 2.

FIG. 4 is a block diagram of a trapezoidal area covered by a photographic image.

FIG. 5 is a block diagram of a rectangular image that covers the trapezoidal area shown in FIG. 4.

FIG. 6 is a block diagram of a plurality of adjoining images.

FIGS. 7-10 are block diagrams of images and transformations thereon.

FIG. 11 is a block diagram of an example system in which images may be rendered.

FIG. 12 is a block diagram of example components that may be used in connection with implementations of the subject matter described herein.

### DETAILED DESCRIPTION

Some map applications allow users to see photographs of the area that is shown in a map. For example, some applications allow users to see a view of an area at street level, where the photos are captured from a moving car. Other applications may show a user aerial images that are captured from a moving airplane.

Images that are captured from an airplane can show a larger area than images that are captured from a car. While a car can only travel along streets, and airplane can take pictures of off-road areas that are not visible from a street. Thus, using aerial images, it is possible to show, for example, a view of an entire square mile of a city. However, using aerial images presents some issues.

Aerial images may be taken at an oblique angle. A camera is mounted on an airplane, and is aimed off to the side of the airplane, pointed diagonally downward—e.g., perhaps at a forty-five degree angle to the ground. Thus, as an airplane flies over a city, it captures many images taken at this angle. Each image might cover an area of only a sixteenth of a square mile. Thus, if a user requests to see a square mile of the city, the composite image of the square mile might actually be sixteen or more separate images stitched together. However, if each image was taken at an oblique angle from a different location, the different perspectives in these images will not allow the images to fit together and appear as if they are a single image taken of the full square mile. Thus, in order to combine the images, the images have to be transformed so that the images match at their connecting boundaries.

Typically, a mosaic is pre-calculated from the original aerial images, and the mosaic is stored on a server so that individual pieces of the mosaic can be delivered to clients in response to client requests. However, pre-calculating the mosaic presents various issues. First, calculating the entire mosaic is computationally expensive. If a particular map application seeks to provide images of, say, all large and mid-sized cities in the United States, thousands or millions of images may be involved. Processing these images may involve millions of hours of computer time. Second, the mosaic that is pre-calculated may suffer from various visual quality issues. The oblique images are taken from a moving airplane, at various different positions, so each image has its own particular perspective. When the images are stitched together, the images are transformed (e.g., stretched, shrunken, warped, etc.) so as to allow them to fit together at their transitional edges. However, these transformations tend to create some unnatural-looking projections. Additionally, because of the expense of storing and transmitting the entire mosaic, the pre-calculated mosaic may be stored at a reduced resolution as compared with the original photos. Moreover, when transformations have to be performed on the mosaic, these transformation are performed on the lower-resolution, transformed images in the mosaic, rather than on the original images themselves.

The subject matter herein may be used to create a composite image of a region from several images of smaller sub-regions. The techniques described herein may be used in place of pre-calculating a mosaic. Thus, these techniques may avoid the computing-time and image quality issues mentioned above (although the subject matter applies even to systems that do not avoid those issues).

In order to provide a composite image, photos are taken. For example, the images that are used to make the composite to be provided to a user may be aerial images of a geographic area, and these images may be constructed from photos that are taken from a moving airplane. In one example, the photos are taken from an airplane traveling high above the ground, and each photo covers, for example, a small patch of ground. When a user requests to see an area (e.g., by using a map application to point to the area on a map, and specifying a specific zoom level), a photo of that location is retrieved. If the entire area that the user wants to see is contained within that single photo, then the user is shown the photo. If the area that the user wants to see is not contained within a single photo, then photos that collectively cover the area are retrieved, and the photos are combined as follows. First, the center of the region that the user wants to see is identified, and the photo whose center is closest to the center of that region is chosen. This photo is used as the central image to be shown to the user. Then, surrounding photos are selected. The central image is shown in its original (untransformed) perspective—i.e., without warping. The surrounding photos are then stitched together with the central image. The surrounding photos are warped so as to match closely the perspective of the central image. After the central image has been surrounded by one layer of surrounding photos, if there are still outlying areas of the user's selected region that are not covered by the central or surrounding photos, then additional surrounding photos are stitched to the image. These additional surrounding photos are warped to match the perspective of the photos to which they adjoin. Thus, the result is an image that contains a central image at its original perspective, surrounded by one or more layers of additional images that have been warped to match the images to which they adjoin. Since the user tends to focus on the center of the image, the main draw of the user's attention will be the natural-looking image at the center. In order to provide an image of the entire region that the user has requested, this image will be supplemented by transformed images in the surrounding areas.

The image that is actually shown to a user may be created based on the original photos captured by the camera. Thus, if the camera has captured high-resolution photos, those high resolution photos may be used for the central image and/or the surrounding images. Additionally, these images have not been subject to arbitrary warping to fit them together in one large mosaic. Rather, the central image is shown in its original perspective, and the surrounding images are warped to match that perspective. Moreover, the computation to perform transformations and to stitch the images together may be performed on a client machine at the time the image is to be displayed, thereby obviating the use of many hours of processor time to pre-calculate the image. Thus, the user may be able to see a higher quality image—at lower pre-calculation cost—than could be delivered through a pre-calculated mosaic.

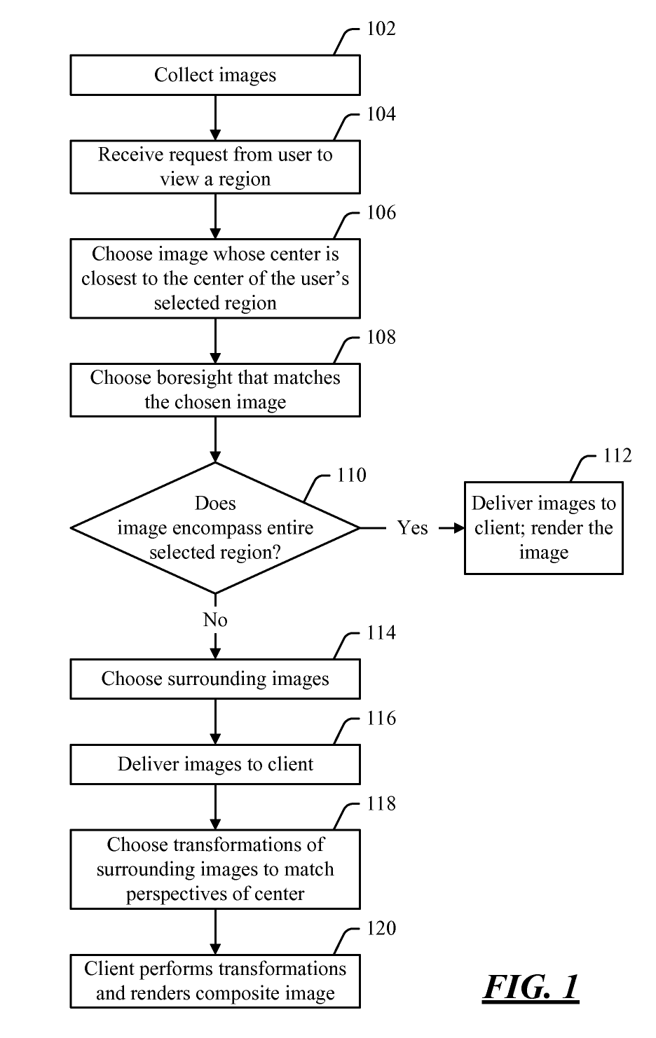

Turning now to the drawings, FIG. 1 shows an example process in which an image may be created and shown to a user. Before turning to a description of FIG. 1, it is noted that the flow diagram of FIG. 1 is described by way of example, with reference to components shown in other figures, although the process of FIG. 1 may be carried out in any system and is not limited to the example scenarios shown in other figures. Additionally, FIG. 1 shows an example in which stages of a process are carried out in a particular order, as indicated by the lines connecting the blocks, but the various stages shown in this diagram can be performed in any order, or in any combination or sub-combination.

At 102, images are collected. In one example, images are taken of a geographic area, and the images are captured from a moving plane. However, the subject matter herein is not limited to the aerial photography scenario, and the images collected at 102 could be collected in any manner.

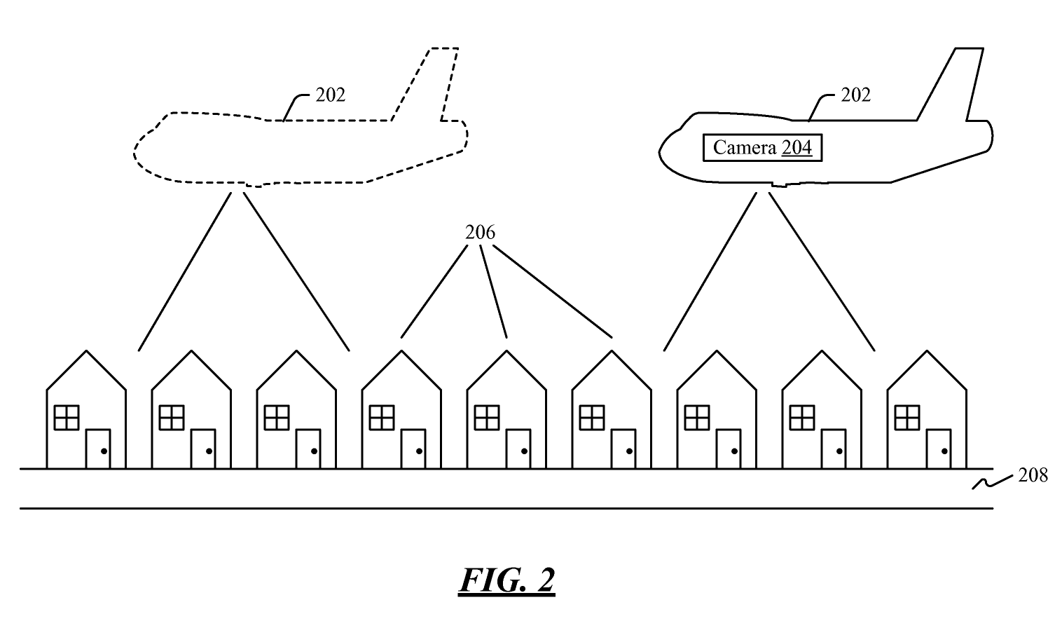

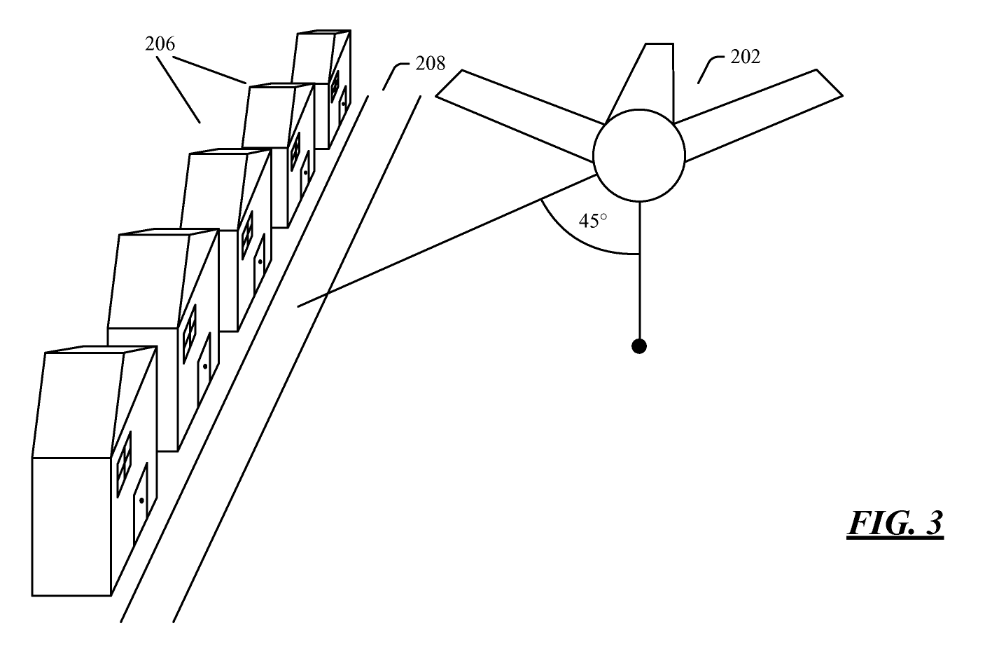

As to the example in which the images collected at 102 are aerial images, this example is shown in FIGS. 2 and 3. FIG. 2 shows an elevation view of a scenario in which photographs of a geographic area are taken from a moving airplane. Airplane 202 flies over a city. As shown in FIG. 2, pictures are taken from airplane 202 as airplane moves forward—e.g., a picture is taken from the position shown by the solid-line airplane 202, and later another picture is taken from the position of dotted-line airplane 202. Camera 204 is mounted on airplane. Camera 204 is typically pointed at an oblique angle (e.g., looking in a direction that is off to the side of the plane, and downward), so that the camera is taking pictures of objects that are not directly below the airplane, but may be quite far off to the side of the plane. In particular, as shown in FIG. 3, the pictures captured from airplane 202 are taken at a forty-five degree angle relative to the perpendicular between airplane 202 and the ground.

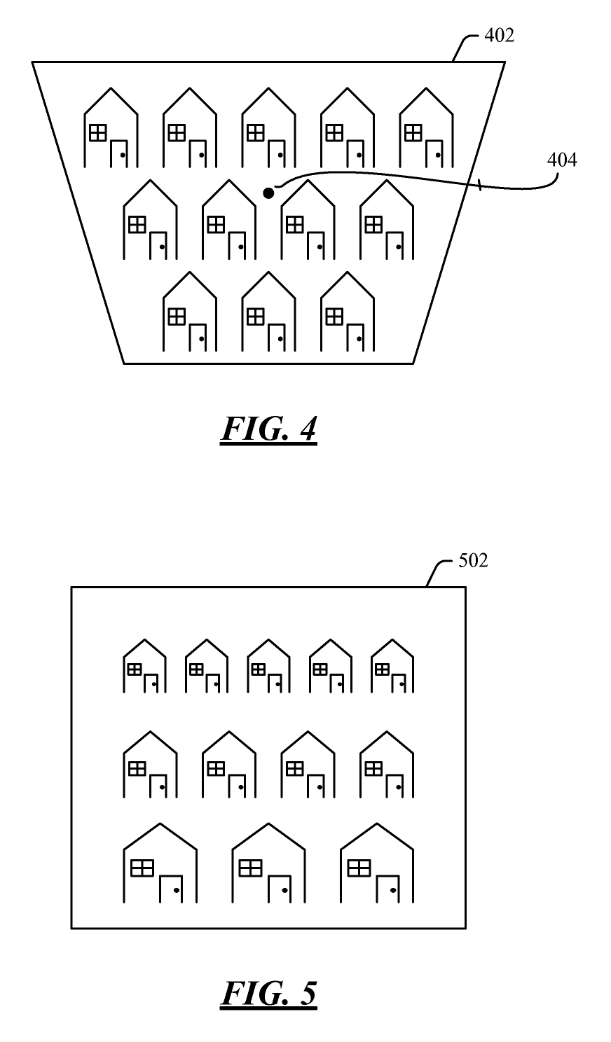

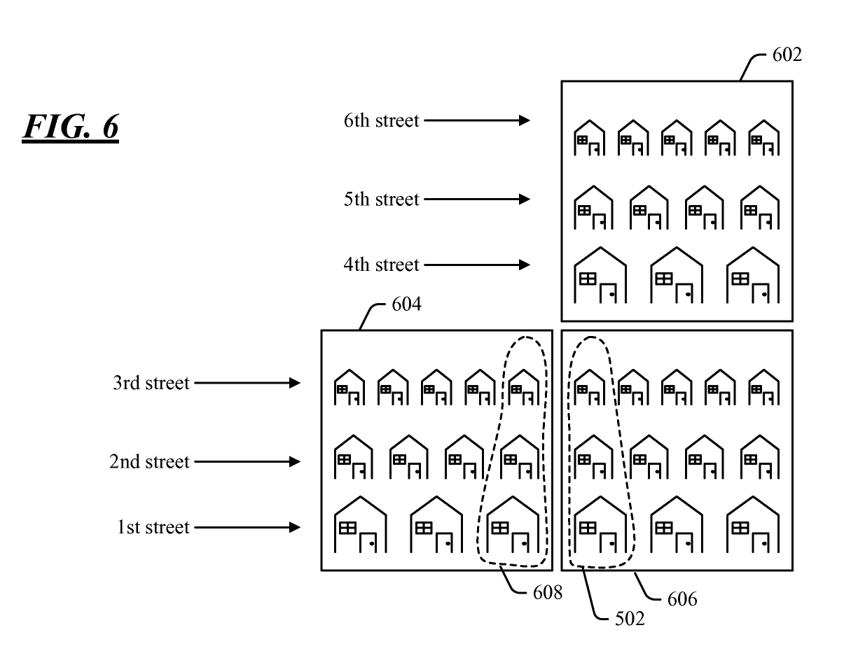

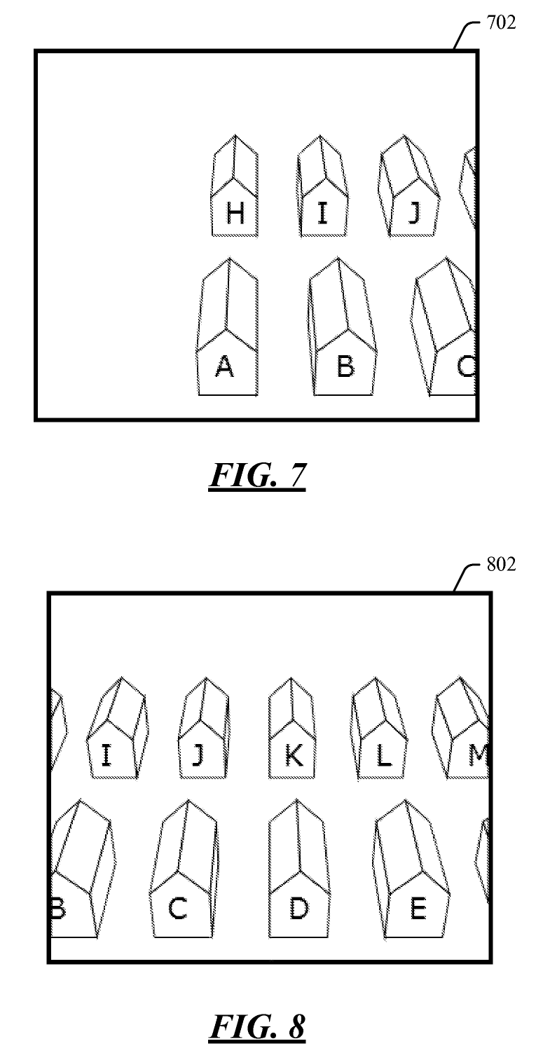

In the example of FIGS. 2 and 3, the camera 204 in airplane 202 is being used to take pictures of houses 206, which are located along street 208. The pictures taken at that angle will show the front and tops of the houses 206, reflecting the fact that the pictures were taken from above and off to the side of houses 206. Additionally, because of the angle from which the pictures are taken, the width that is visible through the lens will be narrower toward the bottom of the image, and wider toward the top of the image. This disparity is due to the fact that objects that are captured near the bottom of the image are closer to the camera, so the viewing angle of the lens does not spread out over as great a distance for close object as it does for a far-away object. Objects near the top of the image are further away than objects near the bottom of the image, so the viewing angle of the lens can spread out over a greater width, thereby capturing a wider range. Thus, if a rectangular image is captured, the image actually covers a trapezoidal area 402 of the terrain, as shown in FIG. 4. (The dot in the center of FIG. 4 represents the boresight 404 of the image—i.e., the vector that corresponds to the direction in which the lens was pointing when the image was captured. The dot is the point at which that vector would intersect the ground.) In FIG. 4, the image shown is that of houses on several parallel streets. As shown, even if it is assumed that the houses are the same size as each other, more houses appear in the row near the top of the image than in the row near the bottom of the image, since the houses at the top of the image are further away from the camera's lens than the houses near the bottom of the image. Thus, the rectangular image 502 that is captured (as shown in FIG. 5) contains more houses near the top than the bottom, but the houses near the top appear narrower and smaller than the houses near the bottom. If two such images are stitched together at their edges, it can be appreciated that the scale of the images will not match at the adjoining edge. For example, in FIG. 6, image 502 (showing 1^{st}, 2^{nd}, and 3^{rd} streets) is adjoined with image 602 showing 4^{th}, 5^{th}, and 6^{th} streets. Even though in the actual geography 3^{rd} street is next to 4^{th} street, the houses on 3^{rd} street appear small, and the houses on 4^{th} street appear large. This is so because the airplane from which the pictures were taken was closer to 4^{th} street when image 602 was taken than it was to 3^{rd} street when image 604 was taken. Thus, when a mosaic is created, one or both of these images may be warped so that their adjoining edges match.

The perspective view from the airplane to the ground may affect the stitching of images in both the vertical (near vs. far) direction, and in the horizontal (along-track) direction of the photograph. For example, the airplane may have been traveling parallel to 1^{st} street, first capturing image 502 and then capturing image 604. Thus, it is likely that only the right sides of the house in column 606 will be visible, and only the left sides of the houses in column 608 will be visible. Thus, the warping of images 502 and/or 604 so that they match at their adjoining edges may result in some odd perspectives, in which the images appear to flow together seamlessly but the direction in which the camera is looking appears to change. Thus, it can be appreciated from FIGS. 4-6 that combining photos that were taken at oblique angles presents some challenges.

At some point after the images are collected (where that point may be months, years, decades, etc., after the images are collected), a request is received to view a particular region (at 104). For example, the images may be referenced in a database that is used by a web-based mapping application, and a user may be using the application to examine maps. At some point, the user may use an interface of the application to request aerial imagery of the location on the map. The user might do so by clicking on a specific point on the map and/or adjusting the zoom. The result of this user interaction with the mapping application is that the application will show some region of the map, and some point within that region will be in the center of the map. In this example, the region that is shown by the application defines the region of which the user has requested to see imagery. Moreover, the center of this region may be used in a specific way that is described below.

At 106, the application chooses the image whose center is closest to the center of the region selected by the user. This image will be used for the center of the image that will be shown to the user, and surrounding images will be placed around this central image. Since the subject matter herein may seek to use the central image in its natural, original form, the orientation of the boresight of the selected image is chosen as the orientation of the composite image that is to be shown to the user (at 108). That is, when the surrounding images are chosen, those images are transformed so as to make it appear as if they were taken along the same boresight vector as the central image that was selected at 106.

At 110, it is determined whether the image selected at 106 encompasses the entire region that is to be shown to the user. If so, then that image can be shown to the user without selecting additional surrounding images. For example, if the user selects a single city block to view, it is possible that such an area may be contained completely within one photograph. In this case, the process of FIG. 1 can simply deliver this image to the client to be rendered (at 112).

On the other hand, if the region to be shown to the user is not contained entirely within one existing image, then the process continues to 114 in order to choose surrounding images and to combine those images with the central image. At 114, the surrounding images are chosen. The surrounding images may comprise a portion of the selected region that is not covered by the center image (where “portion” does not have to indicate “less than all”—i.e., a “portion” of the area not covered by the central image might be some of the non-covered area, but, alternatively, might be all of the non-covered area). Images may be selected that cover regions adjacent to the central image. For example, with reference to FIG. 6, images 602 and 604 are both adjacent to image 502. There may be some overlap among the images. For example, image the houses in columns 606 and 608 might actually be the same houses, captured in the two different photographs. However, these photographs may still be considered adjacent in the sense that one photograph covers some area that is next to the area covered by the other photograph.

At 116, the surrounding images are delivered to the client, and at 118 transformations are chosen to cause the surrounding images to match the perspectives of the center. It is noted that the subject matter herein supports any division of labor between server and client. In one example, the software to choose the images and to perform the transformations is located on the client. In this example, the client may be aware of what images are available on the server and then requests these images from the server and calculates the transformations to be performed on those images. In that case, the server acts as a passive repository of images. However, labor between the client and server could be divided differently. For example, the client could tell the server what region it wants to see, and the server could then choose the appropriate central and surrounding images, and could provide these images to the client to transform. These are a few examples of the division of labor, although any division of labor is possible.

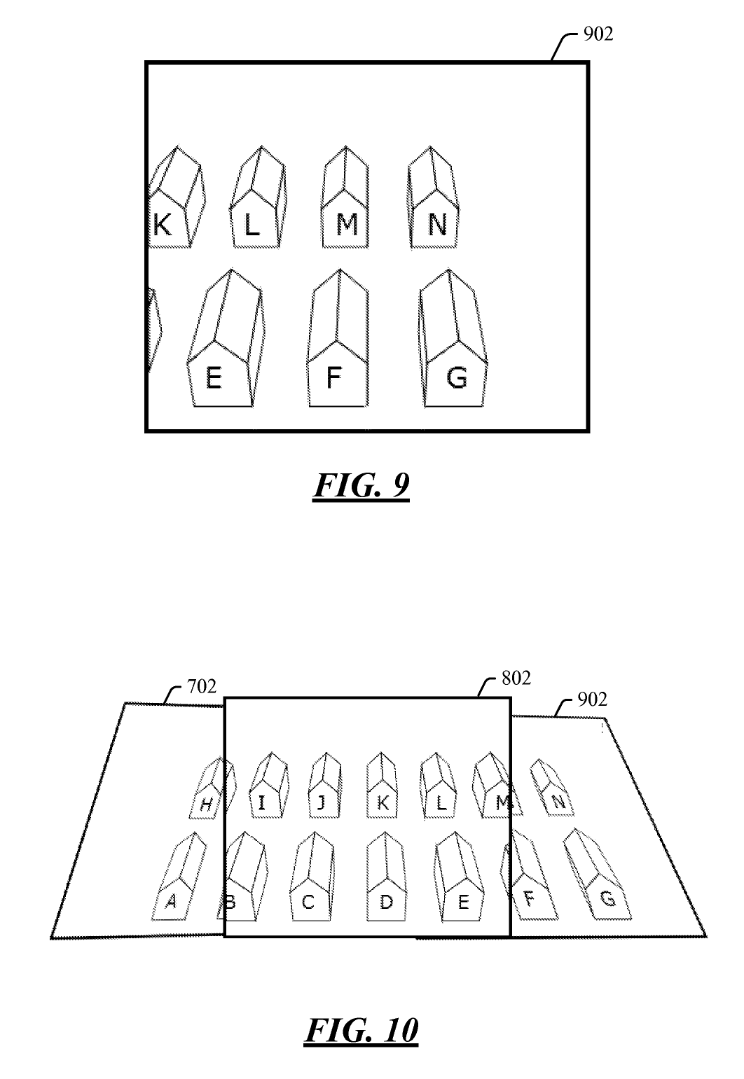

FIGS. 7-10 show an example of how transformations for images are chosen and performed. FIGS. 7, 8, and 9 show three aerial images 702, 802, and 902. The images shown are photographs of houses in a neighborhood, taken as a plane moves parallel to a street. (In this example, the plane moves parallel to a street, although it is noted that the plane could move in any direction, and the subject matter herein is not limited to the case where photographs are taken from an airplane that moves parallel to streets.) It will be observed that houses closer to the camera appear larger, and houses further from the camera appear smaller. One row of houses is labeled A through G, and a second row of houses is labeled H through N. These images are taken from an airplane at three different positions. In image 702, houses A, B, H, I, and J appear, along with portions of houses C and K. In image 802, the airplane is at a different position when the image is taken, so houses C, D, E, I, J, K, and L appear in the image, along with parts of houses H, M, B, and F. In image 902, the airplane is at yet a different position, so houses E, F, G, L, M, and N appear in the image, along with parts of houses D and K.

It will be observed that there is some overlap among the images. For example, houses I and J appear in both of images 702 and 802, but from different perspectives. In particular, in image 702, the left sides of houses I and J are visible. Image 802 on the other hand, having been taken from a different position, shows the right sides of houses I and J. Similarly, images 802 and 902 have some overlap, in that they both show houses E and L (and parts of D and M). In image 802, the left sides of houses E and L are visible, while in image 902 the right sides of those houses are visible.

FIG. 10 shows how images 702, 802, and 902 may be combined into a single image. In FIG. 10, image 802 serves as the central image, and is shown at its original perspective. Images 702 and 902, however, are transformed to match the perspective of image 802. In particular, image 702 is slanted to the right and image 902 is slanted to the left. It will be observed in FIG. 7 (which shows image 702 at its original perspective) that houses A and H appear to ascend straight up in the image and show no detail of the sides of the houses, indicating that the camera was roughly in the same line as houses A and H at the time the image was taken. On the other hand, in the version of image 702 shown in FIG. 10, the line that contains houses A and H appears to ascend upward and to the right, which is how they would appear if the camera had captured those houses from the position at which it captured image 802. Similarly, in the original version of image 902 that appears in FIG. 9 the line containing houses N and G slants slightly upward and slightly to the left. In the transformed version of image 902 that appears in FIG. 10, houses N and G slants more severely to the left, which is how that line of houses would appear if they had been captured from the camera position from which image 802 was taken.

Thus, image 802 in its original perspective, and images 702 and 902 in their transformed perspectives, may be stitched together to form one image to be presented to a user, with image 802 serving as the central image and images 702 and 902 serving at surrounding images.

It is noted that FIGS. 7 through 10 show one central image, with a single surrounding image on each side of that central image. However, further surrounding images could be used. For example, there could be a surrounding image to the left of image 702 and/or to the right of image 902, as well as above and below. These further surrounding images could be transformed to match the perspective of the central image as described above, such that the entire composite image was presented at the same perspective orientation. For example, if there were an image to the left of image 702, that image could be warped so as to match the perspective of image 702 (after image 702 had been warped to allow it to align with the perspective of central image 802). Moreover, FIGS. 7-10 show surrounding images extending horizontally from the central image, but the techniques described herein could be used to extend the central image in additional directions (e.g., images could be placed above and below the central image.) Furthermore, it is noted that the examples of FIGS. 7 through 10 provide a simple illustration of the process described herein. However, this approach may be carried out on any combination of images regardless of the relationship between the orientation of the camera and the surface features.

Returning to FIG. 1, at 120 the transformations may be performed by the client, and a composite image may be rendered based on the transformed images. Thus, the central and surrounding images described above may be transformed to allow their perspectives to match, and then adjoining images may be stitched together along some line that is common to a given pair of images. This composite image may then be displayed to a user. In one example, the surrounding images may be dimmed relative to the center, since dimming the surrounding images may tend to draw the user's attention away from the transformed perspective of these images.

In one example, calculating the transformations involves choosing a surface onto which the images are projected. There are various ways to choose this surface. In one example, the surface is a model of the ground of the area of which the photograph was taken. In another example, the surface is an arbitrary plane. In yet another example, the surface is an arbitrary surface—e.g., a low-resolution triangulated approximation of the terrain over which the photos were taken.

It is also noted that, as a user interacts with an application to choose the region he or she wants to see, the region may change. For example, the user might see one region and then pan left, right, up, or down to see a different region. If the user changes the region, the process described above may be applied to the user's newly selected region. E.g., a new photograph to represent the center may be chosen. This photograph may be chosen, for example, by finding that the new photograph has a center that is closer to the newly-selected region's center than is the center of the previously-chosen central photograph, and that there are no photographs in a database (other than the new photograph) that have a closer center to the newly-selected region than does the newly-selected photograph. Once the new center is chosen, new surrounding photographs may be chosen as well, and these new surrounding photographs may be transformed to align with the perspective of the new central photograph. The new center and surrounding photographs may be combined, and a new composite image may be presented to the user.

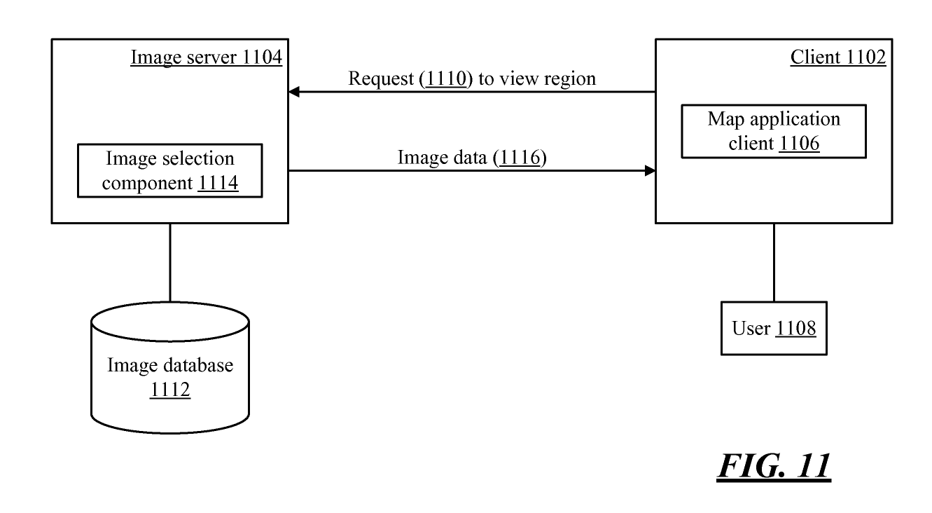

FIG. 11 shows an example system in which images may be rendered. In FIG. 11, a client machine (e.g., client 1102) communicates with an image server 1104. For example, client 1102 may have software such as a map application client 1106. Map application client 1106 may provide a user interface that allows user 1108 to request and view maps, and that also allows user 1108 to request and view photographic imagery of a mapped area. User 1108 controls map application client 1106 to select the area that user 1108 wants to see. For example, user 1108 may use a pointing device to choose the center of the region he or she wants to view, and may use a zoom control to determine how large a region to view around that center. Map application client 1106 could provide any appropriate mechanism to allow user 1108 to choose a region to be viewed.

Once user 1108 has chosen a region to be viewed, map application client 1106 sends, to server 1104, a request 1110 to view that region. Server 1104 accesses an image database 1112 that server 1104 comprises, or otherwise makes use of, where image database 1112 contains images of the area to be viewed. In one example, the images stored in image database 1112 are aerial photographs, although any kind of images could be stored in image database 1112.

Image server 1104 may comprise, or otherwise may make use of, image selection component 1114, which chooses one or more images that encompass the requested region. Image server 1104 sends these images to client 1102 in the form of image data 1116. The software of map application client 1106 then combines the images in the manner described above in connection with FIGS. 1-10, and displays these images to user 1108.

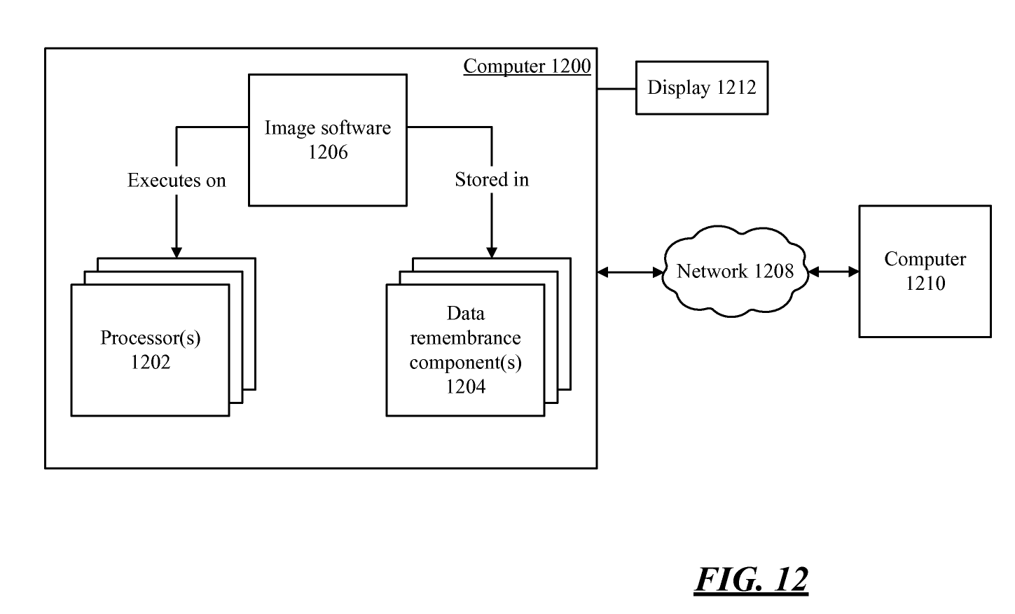

FIG. 12 shows an example environment in which aspects of the subject matter described herein may be deployed.

Computer 1200 includes one or more processors 1202 and one or more data remembrance components 1204. Processor(s) 1202 are typically microprocessors, such as those found in a personal desktop or laptop computer, a server, a handheld computer, or another kind of computing device. Data remembrance component(s) 1204 are components that are capable of storing data for either the short or long term. Examples of data remembrance component(s) 1204 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 1200 may comprise, or be associated with, display 1212, which may be a cathode ray tube (CRT) monitor, a liquid crystal display (LCD) monitor, or any other type of monitor.

Software may be stored in the data remembrance component(s) 1204, and may execute on the one or more processor(s) 1202. An example of such software is image software 1206, which may implement some or all of the functionality described above in connection with FIGS. 1-11, although any type of software could be used. Software 1206 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 12, although the subject matter described herein is not limited to this example.

The subject matter described herein can be implemented as software that is stored in one or more of the data remembrance component(s) 1204 and that executes on one or more of the processor(s) 1202. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 1202) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 1200 may be communicatively connected to one or more other devices through network 1208. Computer 1212, which may be similar in structure to computer 1200, is an example of a device that can be connected to computer 1200, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more non-transitory computer-readable media that store executable instructions to perform a method of presenting an image, wherein the executable instructions, when executed by a computer, cause the computer to perform acts comprising:
receiving a request to view a first region;
choosing, from among a plurality of images, a first image, a center of said first image being closer to a center of said first region than is a center of any other ones of said plurality of images;
choosing, from among said plurality of images, one or more second images that comprise a portion of said first region;
transforming said one or more second images to align with a perspective of said first image;
combining said first image with said one or more second images to form a third image, said third image comprising a portion of said first image, said portion of said first image that appears in said first image appearing in said first image's original perspective; and
displaying said third image.

2. The one or more non-transitory computer-readable media of claim 1, wherein said transforming and said combining are performed by a client, and wherein said acts further comprise:
retrieving said first image and said one or more second images from a server.

3. The one or more non-transitory computer-readable media of claim 1, wherein said acts further comprise:
determining transformations that are to be performed by said transforming act.

4. The one or more non-transitory computer-readable media of claim 1, wherein said first image and said one or more second images are aerial photographs of a geographic area, and wherein said acts further comprise:
projecting said first image and said one or more second images to a plane that approximates a ground of said geographic area.

5. The one or more non-transitory computer-readable media of claim 1, wherein said first image and said one or more second images are aerial photographs of a geographic area, and wherein said acts further comprise:
projecting said first image and said one or more second images to a model surface that approximates a terrain of said geographic area.

6. The one or more non-transitory computer-readable media of claim 1, further comprising:
including said one or more second images in said third image in a dimmed form.

7. The one or more non-transitory computer-readable media of claim 1, further comprising:
receiving a request to pan from said first region to a second region;
determining that a fourth one of said plurality of images has a center that is closer to a center of said second region than said first image's center is to said center of said second region, and that said fourth one of said plurality of images' center is closer to said center of said second region than are centers of any other ones of said plurality of images;
creating a fifth image of said second region in which said fourth one of said plurality of images appears, in untransformed perspective, at a center of said fifth image; and
displaying said fifth image in place of said third image.

8. A method of presenting an image, the method comprising:
using a processor to perform acts comprising:
receiving, from a user, a request to view a first geographic region;
choosing, from among a plurality of images, a first image, a center of said first image being closer to a center of said first geographic region than is a center of any other ones of said plurality of images;
determining that said first image does not contain all of said first geographic region;
choosing, from among said plurality of images, a plurality of second images that comprise a portion of said region;
transforming said one or more second images to align with said first image;
stitching together said first image and said one or more second images to form a third image; and
displaying said third image to said user.

9. The method of claim 8, wherein said displaying is performed by a client, and wherein said acts further comprise:
receiving said first image and said plurality of second images from a server that uses a database of images of geographic areas.

10. The method of claim 8, wherein said acts further comprise:
calculating transformations that are to be performed by said transforming act.

11. The method of claim 8, wherein said acts further comprise:
projecting said first image and said plurality of second images to a plane that approximates a ground of said first geographic region.

12. The method of claim 8, wherein said acts further comprise:
projecting said first image and said plurality of second images to a model surface that approximates a terrain of said first geographic region.

13. The method of claim 8, wherein said acts further comprise:
including said one or more second images in said third image in a dimmed form.

14. The method of claim 8, wherein said acts further comprise:
receiving a request to pan from said first geographic region to a second geographic region;
determining that a fourth one of said plurality of images has a center that is closer to a center of said second geographic region than said first image's center is to said center of said second geographic region, and that said center of said fourth one of said plurality of images is closer to said center of said second geographic region than are centers of any other ones of said plurality of images;
creating a fifth image of said second geographic region in which said fourth one of said plurality of images appears, in untransformed perspective, at a center of said fifth image; and
displaying said fifth image in place of said third image.

15. A system for presenting an aerial image of a geographic area, the system comprising:
a processor;
a data remembrance component; and
a map application client that executes on said processor and that is stored in said data remembrance component, that interacts with a user to receive, from said user, a selection of a first geographic region of which to show an aerial image, that identifies, from a plurality of aerial photos, a first aerial photo such that a center of said first geographic region is closer to a center of said first aerial photo than to centers of any other ones of said plurality of aerial photos, and that identifies, from said plurality of aerial photos, one or more second aerial photos that surround said first aerial photo and that show areas within said first geographic region, wherein said map application creates a first composite image that comprises:
said first aerial photo in untransformed perspective; and
said one or more second aerial photos transformed to match said untransformed perspective of said first aerial photo;
and wherein said map application causes said first composite image to be displayed to said user.

16. The system of claim 15, wherein said map application receives a request to pan from said first geographic region to a second geographic region, determines that a third one of said plurality of aerial photos has a center that is closer to a center of said second geographic region than the center of said first aerial photo is to the center of said second geographic region, creates a second composite image of said second geographic region in which said third one of said plurality of aerial photos appears, in untransformed perspective, at a center of said second composite image, and displays said second composite image in place of said first composite image.

17. The system of claim 15, wherein said map application client receives said first aerial photo and said one or more second aerial photos from a server that accesses a database of aerial photos.

18. The system of claim 15, wherein said map application client calculates transformations that are to be performed on said one or more second aerial photos.

19. The system of claim 15, wherein said map application client includes said one or more second aerial photos in said first composite image in a dimmed form.

20. The system of claim 15, wherein said map application projects said first aerial photo and said second aerial photo to a plane that approximates a ground of said first geographic region.
